(19) United States
(12) Patent Application Publication
(10) Pub. No.: US 2023/0379940 A1
(43) Pub. Date: Nov. 23, 2023

(54) METHOD FOR DEVICE-TO-DEVICE COMMUNICATION

(71) Applicant: Sony Group Corporation, Tokyo (JP)

(72) Inventors: Torgny PALENIUS, Barsebäck (SE); Basuki PRIYANTO, Lund (SE); Anders BERGGREN, Lund (SE); Nafiseh Seyed MAZLOUM, Lund (SE)

(21) Appl. No.: 18/030,736

(22) PCT Filed: Oct. 11, 2021
(86) PCT No.: PCT/EP2021/078071

§ 371 Date: Apr. 6, 2023

(30) Foreign Application Priority Data
Oct. 22, 2020 (SE) 2051235-6

(51) Int. Cl. H04W 72/25; H04W 72/1263

(52) U.S. Cl. CPC H04W 72/25; H04W 72/1263

(57) ABSTRACT

A method carried out in a user equipment, UE, (10) for monitoring a resource pool (41) configured for direct device-to-device communication, comprising: —monitoring (S710) an indicator resource set (42), configured prior to said resource pool; and upon receiving, in the monitored indicator resource set, an indicator signal comprising an identifier associated with said UE; —identifying (S740), based on the received indicator signal, a data channel in the resource pool.

### FIELD OF THE INVENTION

The technology of the present disclosure relates to operations of a user equipment, configured for operation in a wireless network, when conducting device-to-device communication with another device.

### BACKGROUND

In various existing wireless communications systems, a wireless communication device is configured by a wireless network to communicate with other devices via the wireless network. Examples of such wireless networks include cellular systems as provided for under the Third Generation Partnership Project (3GPP), including e.g. 3G, 4G and 5G systems. In such systems, the wireless communication device is frequently referred to as a user equipment (UE), a term which will be used herein as well, even though the proposed solutions are not restricted to operation in a 3GPP type network. The UE communicates with base stations, or access nodes, of the wireless network. Such base stations are referred to as NodeB in 3G networks, eNB in 4G networks and gNB in 5G networks.

In contrast to communication via the wireless network, Device-to-Device (D2D) communication refers to a distributed communication technology that directly transfers traffic between nodes within communication range of each other, such as two UEs, without using the wireless network base station infrastructure. In a D2D communication environment, a UE discovers other UEs physically in proximity thereto and transmits traffic upon setting up a communication session. Historically, D2D communication has been provided by means of different technologies such as infrared communication, Bluetooth, ZigBee, radio frequency identification (RFID) and near field communications (NFC). The 3GPP has also introduced D2D communication as part of the technical specifications for wireless communication in both Long Term Evolution (LTE)/4G and now New Radio (NR)/5G, for use in Proximity-based Service (ProSe). One option for scheduled resource allocation requires that the UE is RRC_CONNECTED in order to transmit data, wherein the access network of the wireless network schedules transmission resources. Another option is that the UE autonomously selects resource. In such a scenario, the UE can transmit data when inside coverage of the access network, irrespective of which RRC state the UE is in, and also when outside coverage of the access network. The UE then autonomously selects transmission resources from resource pool(s).

The term sidelink has been acknowledged as referring to the UE to UE interface in D2D communication, as configured in a 3GPP wireless communication system, e.g. for ProSe direct communication. Sidelink in LTE/4G has been specified since release 14. Sidelink in NR/5G has also been specified in the context of Vehicle-to-Everything (V2X) since release 16. Communication over sidelink may be carried out using resources determined by the wireless network, which resources may be arranged in resource pools. For UEs which are in coverage of the wireless network, the resource pools may be configured by access nodes of the wireless network. For UEs that are out of coverage, pre-configured resources pools for transmission and reception, respectively, may be used by the UEs, e.g. as determined by network association and provided by pre-coding or via a Subscriber Identification Module (SIM) card or similar.

In sidelink communication the UE monitors the channel provided by the resource pool for potential communication. This involves decoding a first stage sidelink control information (SCI) in a physical sidelink control channel (PSCCH) mapped to Sidelink control resources of the resource pool. In the first stage the UE needs to monitor all subchannels corresponding to PSCCH and if a 1st stage SCI is detected, the UE will continue to decode a 2nd stage SCI and the data in a physical sidelink shared channel (PSSCH) mapped to further resources of the resource pool. Since the address of destination UE, of a communication provided in the sidelink resource pool, is included in the second stage SCI, it is only after decoding the 2nd stage SCI that the UE knows whether data has been targeted to it or not. This leads to high power consumption at receiving UEs.

### SUMMARY

Solutions outlined herein provide various improvements to the field of D2D communication and seeks inter alia to target the drawbacks associated with excessive power consumption. The invention is defined by the terms of the claims.

According to a first aspect, a method carried out in a UE is provided, for monitoring a resource pool configured for direct device-to-device communication. The method comprises
monitoring an indicator resource set, configured prior to said resource pool; and upon receiving, in the monitored indicator resource set, an indicator signal comprising an identifier associated with said UE,
identifying, based on the received indicator signal, a data channel in the resource pool.

According to a second aspect, a method carried out in a UE is provided, for transmitting data to a recipient device using a resource pool configured for direct device-to-device communication, comprising
encoding said data onto a data channel of the resource pool; and
transmitting, in an indicator resource set configured prior to said resource pool, an indicator signal comprising an identifier of said recipient device, wherein said indicator signal is configured to identify said data channel.

According to a third aspect, a method carried out in a base station of a wireless network is provided, for facilitating direct device-to-device communication between user equipment, UE, comprising
configuring a resource pool for use by a receiving UE to receive data transmitted from a transmitting UE;
configuring an indicator resource set prior to said resource pool, for use by the receiving UE to monitor reception of an indicator signal comprising an identifier associated with said receiving UE.

By means of the proposed methods, a UE configured to receive D2D communication can dispense with receiving and decoding of all the PSCCH code blocks in a complete resource Rx Pool. Instead, the UE monitors the indicator signal prior to the Rx Pool, such as in advance of the Rx Pool or at initial positions during the Rx Pool, in order to minimize the extra delay and processing required.

### BRIEF DESCRIPTION OF THE DRAWINGS

Various embodiments will be described below with reference to the accompanying drawings.

FIG. 1 is a schematic representation of a wireless network and a UEs capable of communicating by D2D communication.

FIG. 2 is a schematic time-frequency diagram of resource pools for D2D communication according to legacy sidelink configuration.

FIG. 3 is a schematic diagram of resources in a resource pool for D2D communication according to legacy sidelink configuration.

FIG. 4 is a schematic time-frequency diagram of resource pools for D2D communication according to various embodiments of the proposed solution.

FIG. 5 is a schematic diagram indicating association between different resources in an example of the proposed solution.

FIG. 6 schematically illustrates a functional elements of a UE configured to operate the proposed solution.

FIG. 7 is a schematic flowchart of various embodiments of the proposed method, carried out by a receiving UE.

FIG. 8 schematically illustrates a functional elements of a base station configured to operate the proposed solution.

FIG. 9 is a schematic flowchart of various embodiments of the proposed method, carried out by the base station.

### DETAILED DESCRIPTION

In the following description, for purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

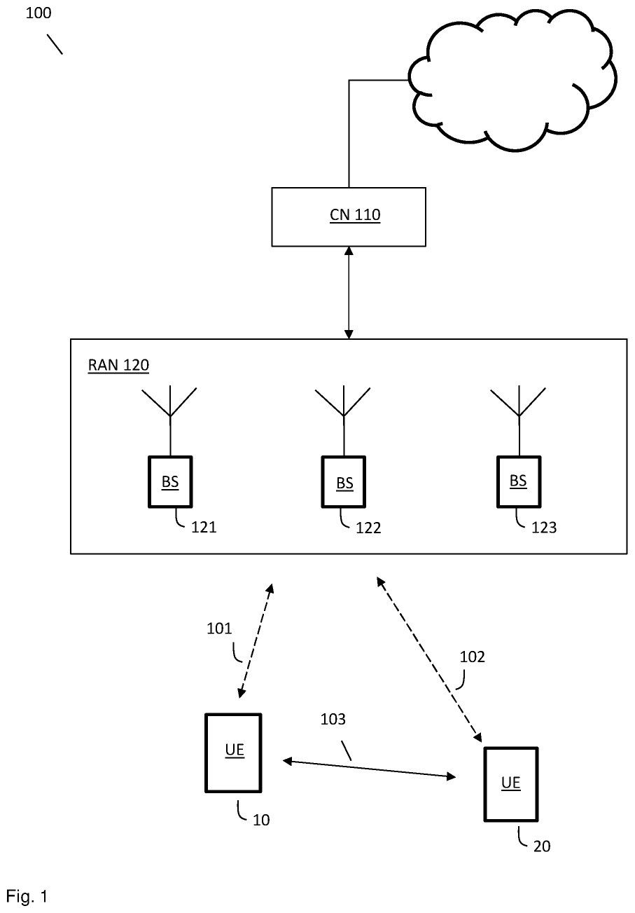

FIG. 1 schematically illustrates a wireless communication scenario, providing an example of a scene in which the solutions provided herein may be incorporated for D2D communication.

A wireless network 100 may comprise a core network (CN) 110 and one or more access networks 120, such as a Radio Access Network (RAN). The wireless network may be configured according to at least some of the specifications as used by the 3GPP technical standard. The core network may e.g. be a 4G EPC or a 5G Core. The core network 110 may further be connected to other communication systems such as the Internet.

The access network 120 is connected to the core network 110 and is usable for communication with UEs, such as the illustrated UEs 10 and 20. The access network 120 may comprise a plurality of access nodes or base stations 121-123, configured to provide a wireless interface for communication 101, 102 with the UEs 10, 20, respectively. The actual point of transmission and reception of each base station may be referred to as a Transmission and Reception Point (TRP), which may coincide with an antenna system of the respective base station. In addition, configuration may be provided for D2D communication 103 directly between two or more UEs 10, 20.

The UE 10 may be any device operable to wirelessly communicate with the network 100 through the base stations 121-123, such as a mobile telephone, computer, tablet, a machine to machine (M2M) device, an IoT (Internet of Things) device or other.

A UE 10 may be configured for D2D communication for different purposes. Various examples for such D2D communication include communication from or to a UE arranged in a vehicle. A concept dented Vehicle-to-everything (V2X) is communication between a vehicle and any entity that may affect, or may be affected by, the vehicle. It is a vehicular communication system that incorporates other more specific types of communication as V2I (vehicle-to-infrastructure), V2N (vehicle-to-network), V2V (vehicle-to-vehicle), V2P (vehicle-to-pedestrian), V2D (vehicle-to-device) and V2G (vehicle-to-grid). The main motivations for V2X are road safety, traffic efficiency, and energy savings. V2X is introduced in Rel-16 for 3GPP specifications for wireless communication. V2X services is just one non-limiting example of D2D communication for which the present solutions may be incorporated. Other advantageous benefits with D2D communication may be the capability of communication also in out-of-coverage situations. In the examples provided below, D2D communication is exemplified as being provide by transmission from the UE 20 for reception in the UE 10. It shall be noted, though that both UEs 10, 20 which are configured for D2D communication shall monitor the channel configured for D2D communication to determine if there is data to be received.

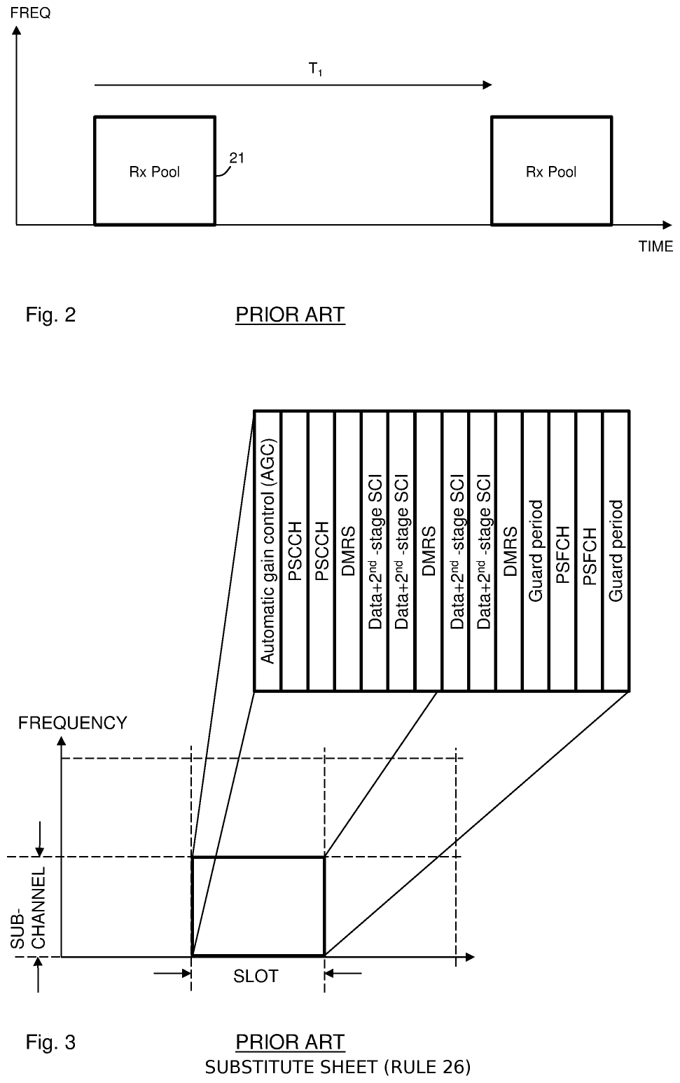

FIG. 2 schematically illustrates a resource pool for communication reception, Rx Pool 21, for use in D2D sidelink communication in a state of the art example. A UE 10 involved in sidelink communication needs to monitor the assigned subchannels on a frequency carrier during the RxPool 21 given by the configuration. As noted, the UE 10 may be configured by direct RRC signaling, by the broadcasted system information from the wireless network 100 or by pre-configurations stored in the UE or a SIM card. As illustrated, the RxPools 21 are resources designated for sidelink communication which can be configured periodically or intermittently. In the drawing, the period T₁ is indicated between successive pools 21 of resources.

FIG. 3 schematically illustrates slot structure of a slot of the Rx Pool 21 according to one example of the prior art, usable for understanding the solutions proposed herein. The slot may comprise elements for Automatic Gain Control (AGC), PSCCH, Demodulation Reference Signals (DMRS), and PSSCH comprising data and 2nd stage SCI. Furthermore, a physical sidelink feedback channel (PSFCH) is provided for e.g. hybrid automatic repeat request (HARQ) purposes. When the UE 10 monitors the Rx Pool 21 for potential data the UE 10 shall monitor all slots and subchannels within the configured RxPool 21. This includes performing blind decoding to detect whether there is a PSCCH received in the slot or not. Moreover, if a PSCCH is received, the UE 10 must detect if the message is addressed to this UE, or to a group in which the UE is a member. This involves that the UE 10 first decodes the PSCCH, which contains the first stage SCI. When the UE 10 successfully decodes the first stage SCI, information about the PSSCH is obtained so the UE 10 can decode the second stage SCI to find the destination ID of the message. Then the UE 10 knows whether the message is for this UE 10 or not.

As can be understood from the above, the power consumption of a UE 10 using sidelink is quite high due to the monitoring of multiple subchannels within the RxPool, since only after decoding of the second stage SCI the UE 10 knows whether there is a data addressed to it or not. This is a problem for UEs with limited power resources, such as pedestrians and cyclists. V2X is designed for e.g. traffic safety where all users shall be able to be aware of each other and take other users into account. In this use case, low latency is very important when there is High Speed traffic around the user. In order for pedestrians and other users having handheld and power constrained devices to be able to receive the information about cars in e.g. a traffic crossing, it is important that it can be performed in a power efficient way.

In this document, we propose a solution to reduce power consumption of the receiving UE in D2D communication. Examples of various details will be outlined below, which fall within the general scope of the proposed methods of reception and transmission of data in D2D communication as set forth in the independent claims.

According to a first aspect, a method carried out in a UE 10 is provided, for monitoring a resource pool configured for direct device-to-device communication. The method comprises
monitoring an indicator resource set, configured prior to said resource pool; and upon receiving, in the monitored indicator resource set, an indicator signal comprising an identifier associated with said UE,
identifying, based on the received indicator signal, a data channel in the resource pool.

According to a second aspect, a method carried out in a UE 20 is provided, for transmitting data to a recipient device using a resource pool configured for direct device-to-device communication, comprising
encoding said data onto a data channel of the resource pool; and
transmitting, in an indicator resource set configured prior to said resource pool, an indicator signal comprising an identifier of said recipient device, wherein said indicator signal is configured to identify said data channel.

By means of the proposed methods, the UE 10 can dispense with receiving and decoding of all the PSCCH code blocks in a complete resource Rx Pool. Instead, the UE 10 monitors the indicator signal prior to the Rx Pool, such as in advance of the Rx Pool or at initial positions during the Rx Pool, in order to minimize the extra delay and processing required.

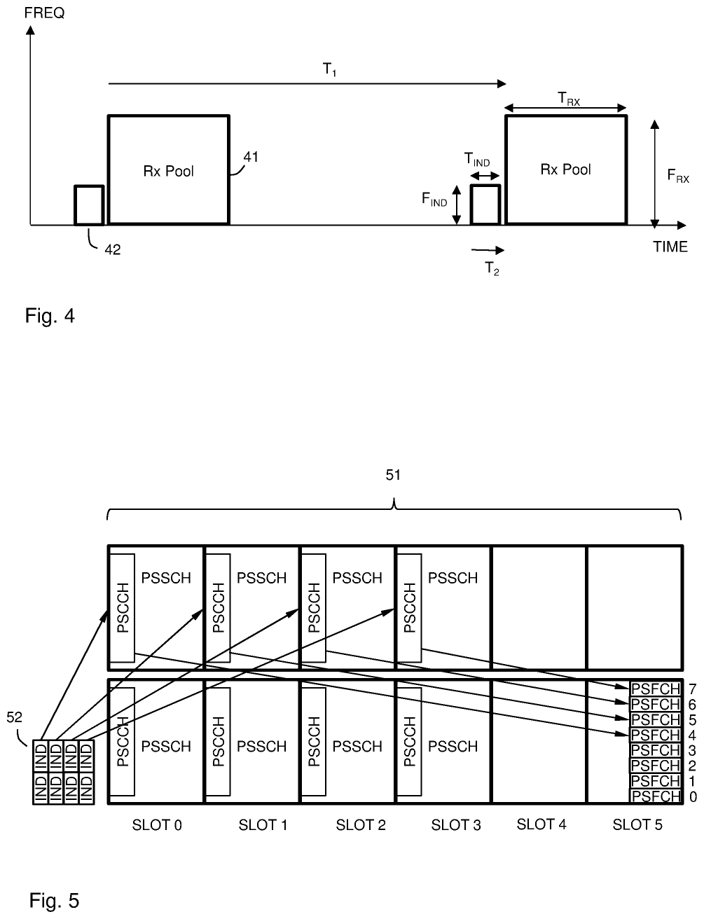

FIG. 4 schematically illustrates an embodiment of the configuration as used in the proposed solution. Herein, a resource pool 41 is allocated to one or more subchannels of the system bandwidth, as configured by the network 100 or as preconfigured. The resource pool 41 may be configured periodically, transmitted with a certain periodicity T₁, or semi-statically with an ON or OFF mechanism controlled by the wireless network 100. Moreover, an indicator resource set 42, which may also be referred to as an indicator Rx Pool, is in this embodiment configured prior to the resource pool 41.

In some embodiments, an offset defining a time gap T₂ between the resources of the indicator resource set 42 and the resources of the resource pool 41 pool may depend on UE capability of the UE 10 which is targeted to receive data. The UE 20 which transmits the indicator signal and data in a subsequent Tx resource pool, for reception in the UE 10 in the resource pool 41, may in some embodiments be configured to know the UE capabilities of the receiving UE 10, either via base station communication or from previous D2D communication with the UE 10. In some embodiments, UEs present in a cell associated with a base station 121, or a larger area, may update the wireless network on its presence. The base station 121 may thus configure the indicator resource set 42, for use in D2D communication, with a time gap T₂ that is set dependent on the UE capabilities of a specific UE 10, a group of UEs, or all UEs, present in the cell or area. The time gap T₂ can be given in absolute value or relative to a reference, for instance number of slots. The length of slots can vary depending on the selected numerology and thereby the number of slots defining the time gap. In various embodiments, the time gap T₂ is thus provided as a number of slots dependent on the selected numerology. Although the drawing indicates the time gap T₂ to refer to an offset between the start of the indicator resource set 42 and the start of the resource pool 41, the time gap T₂ can be defined between any predetermined reference points of the indicator resource set 42 and the resource pool 41, such as from the start or the end of the indicator resource set 42 to the beginning of the resource pool 41. A TX UE may obtain the RX UE capability via sidelink communication or directly from gNB. An RX UE with high performance may have a small time gap between the indicator resource set 42 and the resource pool 41 pool, whereas for other UEs the time gap may be longer. The relative description of the time gap T₂, e.g. in terms of number of slots, may be dependent on selected numerology or sub-carrier spacing of the indicator resource set 42 and the resource pool 41. Higher sub-carrier spacing (SCS) may results in a higher number of slot. As an example: for SCS 30 kHz the gap in terms of slots is 2 slots. For SCS 15 kHz the gap is 1 slot. It shall be noted that the configuration may be such that different SCS may end up in the same absolute value; 1 slot for SCS 15 kHz and 30 kHz are 1 ms and 0.5 ms, respectively, hence 2 slots at 30 KHz SCS is 1 ms. In any case, configuration of the indicator resource set 42 with regard to the resource pool 41 is predetermined or can be determined based on predetermined factors and parameters related to e.g. numerology, such that the transmitting UE 20 and the receiving UE apply the same offset T₂.

In an embodiment related to sidelink, the provision of the indicator resource set 42, the UE 10 only needs to monitor the indicator resources to detect whether there are messages addressed to the UE 10 in the data channel of the resource pool 41, before it actually starts to receive the messages in the PSCCH/PSSCH resources.

At the configured instance of the indicator resource set 42, the UE 10 may be arranged to decode an incoming indicator signal to detect the identifier.

In various embodiments, indicator signal has a modulation and coding scheme which can be decoded with robust performance with a low-power, low-complexity receiver, e.g. noncoherent receivers with low demand of channel estimation. For instance the indicator is selected from sequences with good correlation properties such a ZC sequences or m-sequences. For instance, the indicator is modulated with simple modulation such as OOK modulation. This is possible since the indicator signals is only configured to convey very limited information, such as only the identifier. No fine tune synchronization is needed for its detection, as opposed to SCI/PSCCH detection. In some embodiments, the UE 10 comprises a main receiver for data communication in both D2D communication and with the wireless network 100, and an additional low-power receiver. The low-power receiver may be configured to detect the indicator signal, wherein logic of the UE 10 may be configured to wake up the main receiver responsive to detecting an identifier associated with the UE 10 in the indicator signal. In this sense, the indicator signal is configured to act as a wake-up signal for the main receiver. This way, power is saved at every instance of a resource pool 41 not comprising any message for reception in the UE 10. In some embodiments, the identifier may be a short numeric value, such as 1, 2 or 3 bits, or a longer numeric value.

In some embodiments, the indicator resource set 42 occupies a smaller resource allocation in frequency F_{IND} and/or time T_{IND} than the frequency F_{RX} and/or time T_{RX} of the resource pool 41. In FIG. 4, the bandwidth of the resource pool 41 is indicated by F_{RX} of, whereas the bandwidth of the indicator resource set 42 is indicated by F_{IND}. Clearly, it should be understood that the frequency position of the respective pools 41 and 42 is not restricted to the example provided in the drawings.

In some embodiments, the indicator resource set 42 comprises a preconfigured number of indicator resources. Each of those resources may point to one or more proceeding resources in the pool of resources 41. The UE 10 may be configured to decode each indicator resource to detect an identifier conveyed by means of the indicator signal.

FIG. 5 schematically illustrates an example in which the indicator resource set 52 comprises 8 indicator resource blocks IND and each indicator resource block IND may occupy multiple resource elements. The indicator resource blocks IND can be multiplexed in frequency and time within the indicator resource set 51. The indicator resource blocks IND may be arranged/ordered in a form of time first followed by frequency, as illustrated in the drawing. For example: The first indicator resource can be the bottom left resource and the last indicator resource can be the top right resource. The presence of an indicator signal detected in the respective indicator resource block IND points to at least one corresponding proceeding resource in the resource pool 51. In some embodiments, this entails that the indicator signal informs the UE of a location, e.g. slot and subframe, of the corresponding PSCCH/PSSCH for identifying the data channel which is intended for the UE 10. In some embodiments, this may be arranged by sending the position of said at least one proceeding resource encoded in the indicator signal. In an alternative embodiment, there is a preconfigured one to one mapping between the time/frequency of the respective indicator resource block IND and the time/frequency of associated resources for PSCCH/PSSCH, as indicated by arrows for some resources in the drawing by way of example. The ordering of PSSCH can follow the ordering of indicator resource. The at least one proceeding resource, either a PSCCH or a PSSCH, is determined by the UE 10 based on preconfigured mapping from said indicator resource block IND.

In various situations, the UE 10 may receive a single indicator, i.e. receive an indicator signal comprising an identifier of the UE 10, wherein said indicator points to a specified associated PSSCH carrying payload. In other embodiments, the UE 10 may receive multiple indicators, such that plural data channels are pointed out, by reception in one and the same set of indicator resources 52. In such an embodiment, more than one PSSCH may be allocated to data transfer to the UE 10. This may e.g. be the case where a larger payload of data is transmitted from the same transmitting device, such as UE 20. Alternatively, multiple indicators detected in the indicator resource set 52 may be received from 2 or more sources, wherein the UE 10 is targeted to receive data from more than 1 surrounding device.

By means of the identifier the receiving UE 10 is indicated whether it is a target UE or non-target UE. In some embodiments, the identifier uniquely identifies the UE 10, e.g. within the wireless network 100 or within a group of wireless networks. In other embodiments, the identifier may identify a group of UEs to which said UE 10 belongs. The identifier may in some embodiments identify both a group of UEs to which the UE 10 belongs and an individual ID for the UE 10. In this context, the identifier can be a temporary identifier, provided by the wireless network 100 e.g. in radio resource control (RRC) signaling, and may be assigned to a group of UEs having a common association. The common association may e.g. relate to a mode of operation, such as pedestrian, cyclist, vehicle-based etc., which may be determined by movement pattern based on network-detected movement or UE-reported information, or by pre-configuration of the UE 10. In some embodiments, the identifier may be assigned to identify UEs in a certain area or based on proximity to a certain position.

In order for the UEs to identify which indicators that are applicable for the UE the indicators may contain an optional general ID, for instance the same ID as first stage SCI received in the PSCCH. The general ID may be known to all UEs communicating via D2D communications.

As noted, the indicator serves to identify not only the receiving UE 10 but also a data channel in the resource pool 51. In some embodiments, the proceeding resource to which the identifier points at is a control resource, such as PSCCH, carrying said control information, such as a legacy first stage SCI. In such an embodiment, the UE 10 is configured to decode the control information in the resource pool to identify said data channel, such as a PSSCH. By means of first detecting the identifier, the UE 10 may dispense with further signal reception in the resource pool 51, thus saving power. In another embodiment, the identifier points directly to a shared resource carrying payload for the UE 10, such as a PSSCH. This way, the SCI decoding to obtain payload data may be simplified to further minimize power consumption when there is payload for the UE 10 to obtain in the resource pool 51.

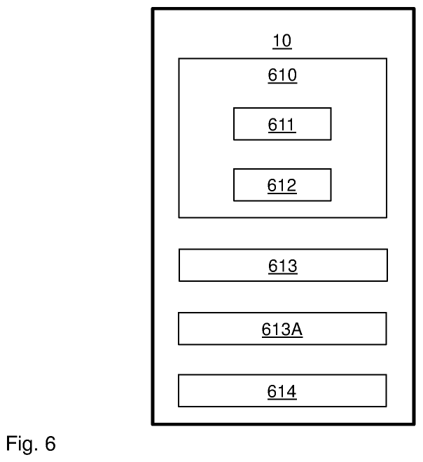

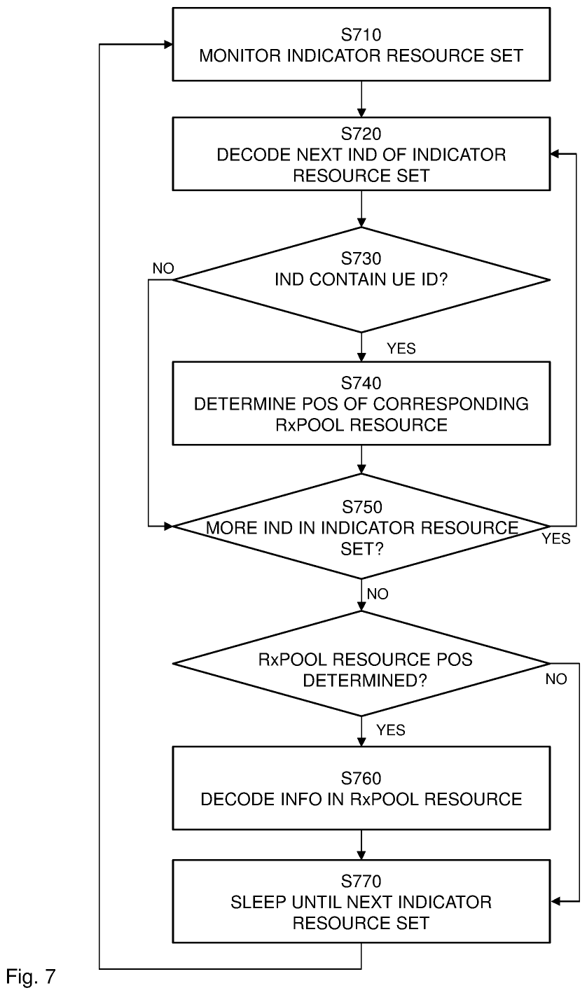

FIG. 6 schematically illustrates an example of the UE 10 for use in D2D communication in accordance with the solutions presented herein. A presentation of various steps included in different embodiments of the proposed method will be described with reference to the flow chart of FIG. 7 below, which may be carried out in the UE 10 configured in accordance with FIG. 6.

The UE 10 comprises logic 610 configured to control operation and communication of the UE 10.

The logic 610 may include a processing device 611, including one or multiple processors, microprocessors, data processors, co-processors, and/or some other type of component that interprets and/or executes instructions and/or data. The processing device 611 may be implemented as hardware (e.g., a microprocessor, etc.) or a combination of hardware and software (e.g., a system-on-chip (SoC), an application-specific integrated circuit (ASIC), etc.). The processing device 611 may be configured to perform one or multiple operations based on an operating system and/or various applications or programs.

The logic 610 may further include memory storage 612, which may include one or multiple memories and/or one or multiple other types of storage media. For example, the memory storage 612 may include a random access memory (RAM), a dynamic random access memory (DRAM), a cache, a read only memory (ROM), a programmable read only memory (PROM), flash memory, and/or some other type of memory. The memory storage 612 may include a hard disk (e.g., a magnetic disk, an optical disk, a magneto-optic disk, a solid state disk, etc.).

The memory storage 612 is configured for holding instructions in the form of computer program code, which may be executed by the processing device 611, wherein the logic 610 is configured to control the UE 10 to carry out any of the method steps as provided herein. Software defined by said computer program code may include an application or a program that provides a function and/or a process. The software may include device firmware, an operating system (OS), or a variety of applications that may execute in the logic 610.

The UE 10 further comprises a radio transceiver 613 for communicating with other entities of the wireless network 100 on a radio channel, such with the base stations 121-123 and by D2D communication with other UEs 20, in various frequency bands. The transceiver 613 may thus include a radio receiver and transmitter for communicating through at least an air interface. In some embodiments, the UE 10 further comprises a low-power receiver 613A, which is configured for detection of a low-complexity signal, including the indicator signal in D2D communication. As outlined above, signal detection by the low-power receiver 613A may cause the logic 610 to wake up the main receiver of transceiver 613. In some embodiments, the bandwidth of an indicator resource block IND, for detection of an indicator signal, is more limited than the bandwidth of a data channel, e.g. PSSCH, in the pool of resources 41 to which the indicator signal points. This way, a less complex receiver 613A may be used for receiving the indicator signal, wherein the main receiver 613 for data channel reception may be activated responsive to the indicator signal being received.

The UE 10 may further comprise an antenna system 614, connected to the transceiver 613, which may include one or more antenna arrays.

Obviously, the UE 10 may include other features and elements than those shown in the drawing or described herein, such as a power supply, a casing, a user interface, sensors, etc., but these are left out for the sake of simplicity.

FIG. 7 provides a flowchart in which various steps of different embodiments of the method outlined herein are shown by way of example. Various steps of the method as shown in the example may be included in different embodiments, as made clear throughout the description. Cross-reference to other drawings will be made at various places, for the sake of clarity. The flowchart relates to a method carried out in the UE 10 for monitoring a resource pool 41,51 configured for direct device-to-device communication. The resource pool 41,51 may be periodically or semi-statically configured by a wireless network provider, e.g. by configuration from the wireless network 100 or by pre-configuration. In various embodiments, the resource pool 41,51 is an Rx resource pool configured for sidelink communication.

In step S710 the UE 10 monitors an indicator resource set 42,52, configured (i.e. occurring) prior to said resource pool 41,51. In some embodiments, the indicator resource within the resource set 42,52 occupies a narrower frequency band or may occupy a shorter time period than the resource pool 41,51.

Monitoring the indicator resource set may entail decoding S720 of an indicator signal received in a first indicator resource block IND of the indicator resource set 42,52, to detect an identifier associated with said UE 10.

The UE 10 may be configured to determine S730 whether an identifier received in the first indicator resource block IND uniquely identifies the UE 10, and/or a group of UEs to which said UE 10 belongs.

Upon receiving an indicator signal comprising an identifier associated with said UE, the UE may be configured to identify S740, based on the received indicator signal, a data channel, such as a PSSCH, in the resource pool 41,51. In some embodiments, a proceeding resource associated with the data channel is determined based on a preconfigured mapping from the respective indicator resource block IND.

In various embodiments, where the indicator resource set 42,52 comprises a plurality of indicator resources IND, these indicator resources IND may be successively assessed S750 to decode S720 the respective indicator resource block IND and to determine S730 whether an indicator signal received in the respective indicator resource block IND has conveyed an identifier of the UE 10. In this process, a plurality of indicator resource blocks IND may be determined S740 to point to a plurality of proceeding resources of the resource pool 41,51.

Where one or more proceeding resources of the resource pool 41,51 have been identified or pointed out in step S740, based on the received indicator signal, the UE 10 may proceed to decode S760 information in the associated proceeding resources in the resource pool 41,51. The indicator resource set is in some embodiments monitored with a low-power receiver 613A, wherein logic 610 of the UE 10 is configured to wake up a main receiver 613 for reception of information S760, responsive to a received indicator signal comprising the identifier associated with said UE 10.

In some embodiments, the indicator resource block IND in which the identifier was detected points directly to a shared resource carrying data, such as a PSSCH, of the resource pool 41,51. In such an embodiment, indicator resource block IND in which the identifier was detected points to a control resource, such as PSCCH, carrying said control information, such as SCI. In such an embodiment, the step of decoding information S760 may comprise determining the control resource based on the indicator signal, and decoding control information in the resource pool to identify said data channel, such as an associated PSSCH.

When monitoring S710 of the indicator resource set does not result in the detection of any indicator signal comprising an identifier of the UE 10 in any indicator resource, signal reception in the resource pool 41,51 may be dispensed with S770, until the next cycle or instance of an indicator resource set 42,52 or resource pool 41,51. In other words, the UE 10 is configured to not proceed with signal reception in the resource pool 41,51. This way, power of the UE 10 is saved. Where a low-power receiver 613A is used, this means additional power saving, since the main receiver 613 never has to be powered up during the current period or instance of the resource pool 41,51.

Where an identifier of the UE 10 is detected S730 in the indicator resource set 42,52, decoding of information in the resources of the resource pool 41,51 is limited to the proceeding resources pointed out by the associated indicator resources IND in which the identifier was detected. For the remaining resources of the resource pool 41,51, signal reception may be dispensed with. This way, power of the UE 10 is saved. After decoding the last resource pointed out by the indicator resources IND, the main receiver 613 may sleep S770 until next indicator resource set 42,52.

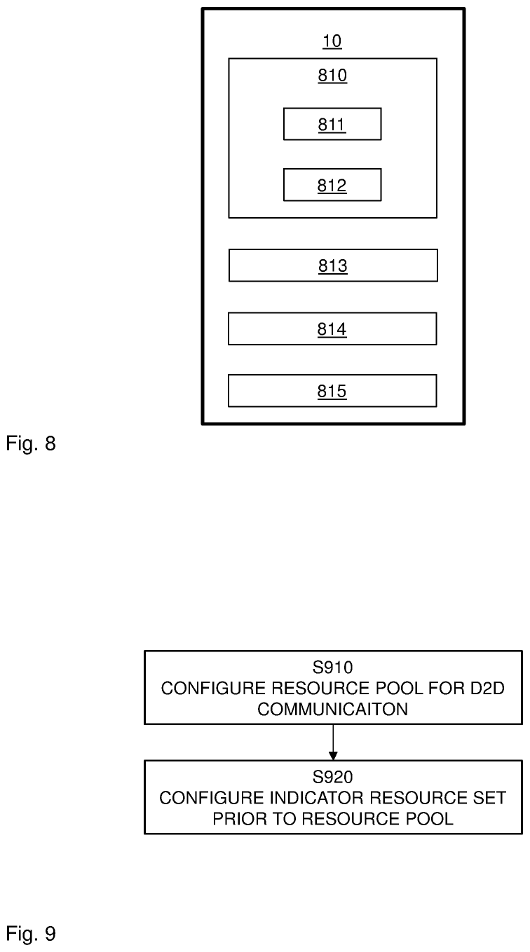

FIG. 8 schematically illustrates an example of a base station 121 for use in a radio communication network 100 as presented herein, and for carrying out various method steps as outlined herein.

The base station 121 comprises one or more radio transceiver(s) 813 for wireless communication with other entities of the radio communication network 100, such as the UE 10. The transceiver 813 may thus include a radio receiver and transmitter for communicating through at least an air interface, such as with UEs 10,20.

The base station 121 further comprises logic 810 configured to communicate data, via the radio transceiver(s), on a radio channel, with UE 10. The logic 810 may include a processing device 811, including one or multiple processors, microprocessors, data processors, co-processors, and/or some other type of component that interprets and/or executes instructions and/or data. The processing device 811 may be implemented as hardware (e.g., a microprocessor, etc.) or a combination of hardware and software (e.g., a system-on-chip (SoC), an application-specific integrated circuit (ASIC), etc.). The processing device 811 may be configured to perform one or multiple operations based on an operating system and/or various applications or programs.

The logic 810 may further include memory storage 812, which may include one or multiple memories and/or one or multiple other types of storage mediums. For example, memory storage 812 may include a random access memory (RAM), a dynamic random access memory (DRAM), a cache, a read only memory (ROM), a programmable read only memory (PROM), flash memory, and/or some other type of memory. Memory storage 812 may include a hard disk (e.g., a magnetic disk, an optical disk, a magneto-optic disk, a solid state disk, etc.).

The memory storage 812 is configured for holding computer program code, which may be executed by the processing device 811, wherein the logic 810 is configured to control the base station 121 to carry out any of the method steps as provided herein. Software defined by said computer program code may include an application or a program that provides a function and/or a process. The software may include device firmware, an operating system (OS), or a variety of applications that may execute in the logic 810.

The base station 121 may further comprise or be connected to an antenna 814, connected to the radio transceiver 813. The base station may further comprise one or more interfaces 815 for communication with further nodes of the wireless network 100, such as with the core network 110.

A method carried out by the base station 121 is shown in the flow chart of FIG. 9. In various embodiments, the base station 121 is configured to facilitate direct D2D between user equipment, such as UE 10 and UE 20. The logic 810 may thereby be arranged to
configure S910 a resource pool 41 for use by a receiving UE 10 to receive data transmitted from a transmitting UE 20; and
configure S920 an indicator resource set 42 prior to said resource pool, for use by the receiving UE 10 to monitor reception of an indicator signal comprising an identifier associated with said receiving UE.

The indicator resource set 42 may be configured to identify a data channel in the resource pool, such as by pointing out or identifying a PSCCH or a PSSCH. The indicator resource set may be configured to occupy a smaller resource allocation in frequency and/or time than the resource pool. Specifically, the indicator resource set may be configured to receive an indicator signal in an indicator resource block IND in the set of indicator resources, which indicator resource block IND occupies a smaller bandwidth than the data channel which is identified, e.g. a PSSCH, and optionally also smaller than a control channel in the resource pool, e.g. a PSCCH, which specifically identifies the data channel. The resource pool may be an Rx resource pool configured for sidelink communication. In some embodiments, the indicator resource set is configured with an offset T₂ prior to the resource pool, wherein said offset T₂ is set dependent on UE capability of at least said receiving UE (10). In some embodiments, the base station is a gNB.

Various embodiments have been outlined in the foregoing, providing examples of the solutions provided by the method as set out in the independent claims. The proposed solution targets power efficiency in the context of D2D communication. Power efficiency is particularly important for pedestrians and other power-limited UEs using sidelink for traffic safety. The benefits provided by the proposed solution include the possibility of UEs which are mainly focused on monitoring data to receive, to effectively identify whether a configured resource pool for D2D communication in fact carries any data for them, without having to carry out extensive signal processing. Such UEs may further make use of a lower-power receiver with low duty cycle when monitoring the channel for sidelink reception. It may be noted that although the present disclosure describes the proposed solution mainly with reference to resources configured for reception, corresponding resources of an indicator resource set and resource pool, such as a Tx Pool for sidelink, are configured for transmission.

The proposed solution may be provided by any combination of the subject matter as set out in the foregoing.

1. A method carried out in a user equipment (UE) for monitoring a resource pool configured for direct device-to-device communication, comprising:
monitoring an indicator resource set, configured prior to said resource pool; and
upon receiving, in the monitored indicator resource set, an indicator signal comprising an identifier associated with said UE, identifying, based on the received indicator signal, a data channel in the resource pool.

2. The method of claim 1, comprising: decoding the indicator signal to detect said identifier.

3. The method of claim 1, wherein said indicator resource set comprises a preconfigured number of indicator resources.

4. The method of claim 3, comprising: decoding each indicator resource of the indicator resource set, to detect said identifier.

5. The method of claim 1, wherein information in the indicator signal points to at least one proceeding resource in the resource pool.

6. The method of claim 5, wherein said identifier is received in a first indicator resource of the indicator resource set; and wherein the at least one proceeding resource is determined based on preconfigured mapping from said first indicator resource.

7. The method of claim 5, wherein the proceeding resource is a control resource carrying control information, comprising: determining the control resource based on the indicator signal, and decoding control information in the resource pool to identify said data channel.

8. The method of claim 5, wherein the proceeding resource is a shared resource carrying data.

9. The method of claim 1, wherein said identifier uniquely identifies said UE.

10. The method of claim 1, wherein said identifier identifies a group of UEs to which said UE belongs.

11. The method of claim 1, wherein said resource pool is periodically or semi-statically configured.

12. The method of claim 1, wherein the indicator resource set occupies a narrower frequency band of than the resource pool.

13. The method of claim 1, wherein the indicator resource set is monitored with a first, low-power, receiver, comprising: waking up a main receiver for reception in the data channel responsive to the indicator signal comprising the identifier associated with said UE.

14. The method of claim 1, wherein upon not receiving, in the monitored indicator resource set, any indicator signal comprising an identifier associated with said UE, not proceeding with signal reception in the resource pool.

15. The method of claim 1, wherein said resource pool is configured by a wireless network provider.

16. The method of claim 1, wherein said resource pool is an Rx resource pool configured for sidelink communication.

17. A method carried out in a user equipment (UE), for transmitting data to a recipient device using a resource pool configured for direct device-to-device communication, comprising:
encoding said data onto a data channel of the resource pool; and
transmitting, in an indicator resource set configured prior to said resource pool, an indicator signal comprising an identifier of said recipient device, wherein said indicator signal is configured to identify said data channel.

18. The method of claim 17, wherein said indicator resource set comprises a preconfigured number of indicator resources.

19. The method of claim 17, wherein information in the indicator signal points to at least one proceeding resource in the resource pool.

20-28. (canceled)

29. A method carried out in a base station of a wireless network for facilitating direct device-to-device communication between user equipment (UE), comprising:
configuring a resource pool for use by a receiving UE to receive data transmitted from a transmitting UE; and
configuring an indicator resource set prior to said resource pool, for use by the receiving UE to monitor reception of an indicator signal comprising an identifier associated with said receiving UE.

30-33. (canceled)
